(19) United States
(12) Patent Application Publication
(10) Pub. No.: US 2012/0075624 A1
(43) Pub. Date: Mar. 29, 2012

(54) METHOD AND APPARATUS FOR INSPECTING MAGNETIC DISK

(75) Inventors: Ryuta SUZUKI, Kamisato (JP); Masayuki YAMAMOTO, Kamisato (JP); Toshiaki SUGITA, Kamisato (JP)

(73) Assignee: HITACHI HIGH-TECHNOLOGIES CORPORATION, Tokyo (JP)

(21) Appl. No.: 13/210,494

(22) Filed: Aug. 16, 2011

(30) Foreign Application Priority Data
Sep. 29, 2010 (JP) 2010-218990

(51) Int. Cl. G01N 21/00

(52) U.S. Cl. 356/237.2

(57) ABSTRACT

In magnetic disk inspection, it is made possible to perform the total operation in which magnetic disks taken out from a cassette are inspected on both surfaces thereof, classified by the grades according to the inspection results and returned again to corresponding cassettes, while maintaining high throughput. To achieve such inspection, a plurality of uninspected boards are put on a plurality of corresponding rotation-drive portions at a plurality of corresponding board taking-out and supply positions in a magnetic disk inspection apparatus and are transferred to a plurality of corresponding inspection positions. The boards are optically inspected while rotating. The optically inspected boards are transferred to the plurality of corresponding board taking-out and supply positions and the plurality of transferred boards are taken out. The taken-out boards are sorted according to the optical inspection results and stored in the corresponding cassettes into which inspected boards are stored.

### BACKGROUND OF THE INVENTION

The present invention relates generally to an inspection apparatus for inspecting a magnetic disk and in particular to a magnetic disk inspection apparatus and method suitable to optically inspect flaws, foreign matter and the like on both surfaces of a magnetic disk.

Magnetic disks (media) have increased in recording density year by year. With this, the size of a defect on the disk surface to be controlled in a manufacturing step has reduced. On the other hand, the magnetic disks have to be manufactured while maintaining throughput at a conventional rate. In order to ensure sufficient inspection time to detect a minute defect, handling time to take disks in and out an inspection apparatus is reduced. In addition, minute foreign matter has to be prevented from adhering to the disk surface as much as possible during taking-in and -out of the disk from the inspection apparatus.

A magnetic disk is formed with magnetic films on both surfaces of a board; therefore, both the surfaces of the board have to be inspected with the same accuracy. As a method of inspecting both surfaces, one surface of the board is first inspected, the board is next reversed and the other surface is inspected. JP-A-2008-32415 (patent document 1) describes the following constitution as a method of sequentially inspecting both surfaces of the board one by one. In the method, an inspection apparatus provided with two spindles uses a handling robot by which a disk is mounted to a first spindle to be inspected on one surface thereof, then the disk is reversed and mounted to a second spindle. Then, after the inspection of the other surface has been finished, the disk is removed from the second spindle and is transferred to a disk discharge position by the handling robot.

In order to ensure a high degree of inspection accuracy while maintaining inspection throughput, it is important to reduce the handling time for transfer of a disk into and from the inspection apparatus and for reversal of the disk as much as possible. The time for the transfer of the disk into and from the inspection apparatus includes the time for taking out a disk from a cassette, and the time for sorting the inspected disks according to the inspection results to return them to the corresponding cassettes.

However, the invention described in patent document 1 does not consider improving the throughput of total operation including the time for taking out disks from a cassette, and the time for sorting the inspected disks according to the inspection results to return them to the corresponding cassettes.

In order to improve the total throughput, a method of preparing and concurrently operating a plurality of inspection units may be conceivable. However, simply increasing the number of the inspection units increases the installation floor area (footprint) for the apparatuses, which will inevitably enlarge the facility. In addition, there occurs a disadvantage in which dust production sources are increased to cause defects such as foreign matter.

### SUMMARY OF THE INVENTION

The present invention provides a magnetic disk inspection apparatus and method that can make it possible to perform, in a low-dust production environment, total operation in which both surfaces of magnetic disks taken out from a cassette are inspected, and the magnetic disks are divided into grades according to the inspection results and returned again to corresponding cassettes, while maintaining high throughput.

According to an aspect of the present invention, there is provided a magnetic disk inspection apparatus including: an optical inspection unit optically inspecting a defect on a board; a table unit including a plurality of board rotation-drive portions on which the boards are put to be rotated, the table unit turning for transferring the boards put on the corresponding board rotation-drive portions between a position where the board put on the board rotation-drive portion is inspected by the optical inspection unit and a position where the board is taken out and supplied; a cassette portion housing a cassette storing an uninspected board and a cassette storing an inspected board; and a board handling unit taking out the uninspected board from the uninspected board storing cassette provided in the cassette portion, and supplying the uninspected board to the board rotation-drive portion of the table unit, the board handling unit taking out the board having both surfaces subjected to inspection by the optical inspection unit from the board rotation-drive portion and storing the board into the inspected board storing cassette provided in the cassette portion; wherein the optical inspection unit and the table unit are each provided a plurality of numbers, and the board handling unit concurrently takes out a plurality of boards inspected by the plurality of inspection units from the plurality of table units and concurrently supplies a plurality of uninspected boards to the plurality of table units.

According to another aspect of the present invention, there is provided a magnetic disk inspection method including the steps of: taking out a plurality of uninspected boards stored in a cassette, from the cassette; putting the plurality of boards taken out from the cassette on a plurality of corresponding rotation-drive portions at a plurality of corresponding board taking-out and supply positions in a magnetic disk inspection apparatus; transferring the boards put on the plurality of corresponding rotation-drive portions to a plurality of corresponding inspecting positions; optically inspecting, through light irradiation, the plurality of boards transferred to the plurality of corresponding inspecting positions while allowing the rotation-drive portions to rotate the plurality of corresponding boards; transferring the plurality of optically inspected boards to the plurality of corresponding board taking-out and supply positions in a state where the plurality of optically inspected boards are put on the plurality of corresponding rotation-drive portions; taking out the plurality of optically inspected boards transferred to the plurality of corresponding board taking-out and supply positions; and sorting the plurality of taken-out boards in accordance with results of the optical inspection and storing the sorted boards into corresponding cassettes into which inspected boards are stored.

The present invention can make it possible to perform, in a low-dust production environment, the total operation for the magnet disk inspection in which both surfaces of magnetic disks taken out from a cassette are inspected and the magnetic disks are divided into grades according to the inspection results and returned again to corresponding cassettes, while maintaining high throughput.

These features and advantages of the invention will be apparent from the following more particular description of preferred embodiments of the invention, as illustrated in the accompanying drawings.

### BRIEF DESCRIPTION OF THE DRAWINGS

FIG. 1A is a plan view illustrating a schematic configuration of a magnetic disk inspection apparatus according to an embodiment of the present invention.

FIG. 1B is a front view illustrating the schematic configuration of the magnetic disk inspection apparatus according to the present invention.

FIG. 2 is a front view illustrating a schematic configuration of an optical inspection unit according to the embodiment of the present invention.

FIG. 3 is a perspective view illustrating a configuration of a chuck portion of a board handling unit according to the embodiment of the present invention.

FIG. 4 is a perspective view illustrating a configuration of chucks 421A, 421B of the chuck portion of the board handling unit according to the embodiment of the present invention.

FIG. 5 is a perspective view illustrating a configuration of chucks 422A, 422B of the chuck portion of the board handling unit according to the embodiment of the present invention.

FIG. 6 is a perspective view illustrating a configuration of a chuck portion of a board reversing unit according to the embodiment of the present invention.

FIG. 7 is a flowchart illustrating a flow of processing of the magnetic disk inspection apparatus according to the embodiment of the invention.

FIG. 8 is a flowchart illustrating a detailed flow of inspected board taking-out and uninspected board mounting in steps A701 and B707 in the flow of the processing of the magnetic disk inspection apparatus according to the embodiment of the present invention.

FIG. 9 is a flowchart illustrating a detailed flow of processing of steps 803 and 804 of the processing flow illustrated in FIG. 8, according to the embodiment of the present invention.

FIG. 10 is a flowchart illustrating a flow of processing for reversing a magnetic disk whose one side has been inspected, according to the embodiment of the present invention.

### DETAILED DESCRIPTION OF THE PREFERRED EMBODIMENTS

Preferred embodiments of the present invention will hereinafter be described with reference to the drawings.

### First Embodiment

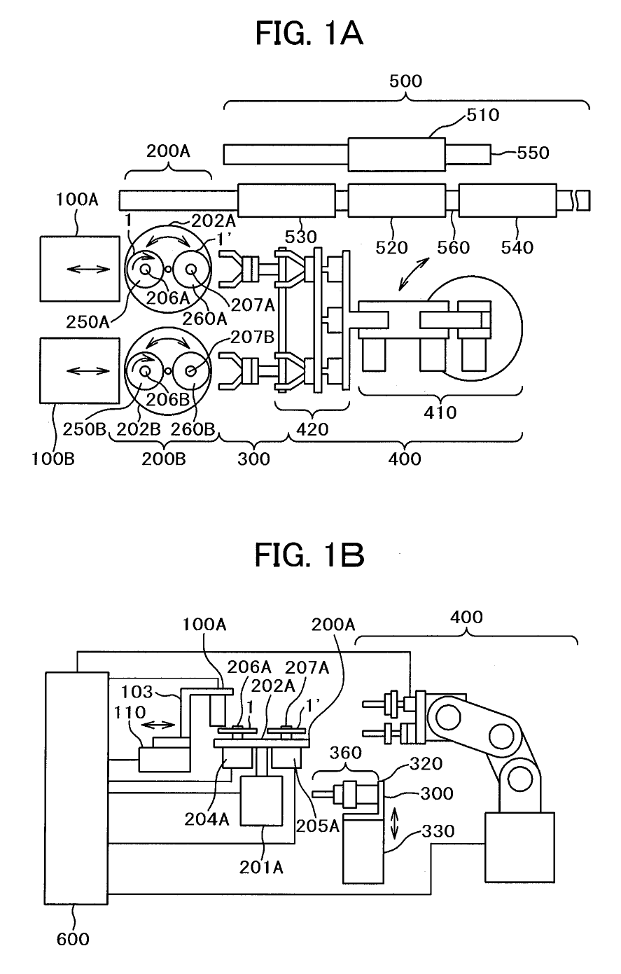

FIGS. 1A and 1B illustrate the entire configuration of a magnetic disk inspection apparatus according to the present embodiment. FIG. 1A is a plan view illustrating the schematic configuration of the magnetic disk inspection apparatus according to the embodiment and FIG. 1B is a front view of FIG. 1A. The present embodiment employs a method of concurrently inspecting two magnetic disks by use of two sets of optical inspection apparatuses in order to increase the throughput of the inspection apparatus.

Referring to FIG. 1A, there are shown optical inspection units 100A, 100B, table units 200A, 200B, a board reversing unit 300, a board handling unit 400 and a cassette unit 500. In addition, there is shown a signal processing and control unit 600 in FIG. 1B.

FIG. 1B illustrates a combination of the optical inspection unit 100A and the table unit 200A.

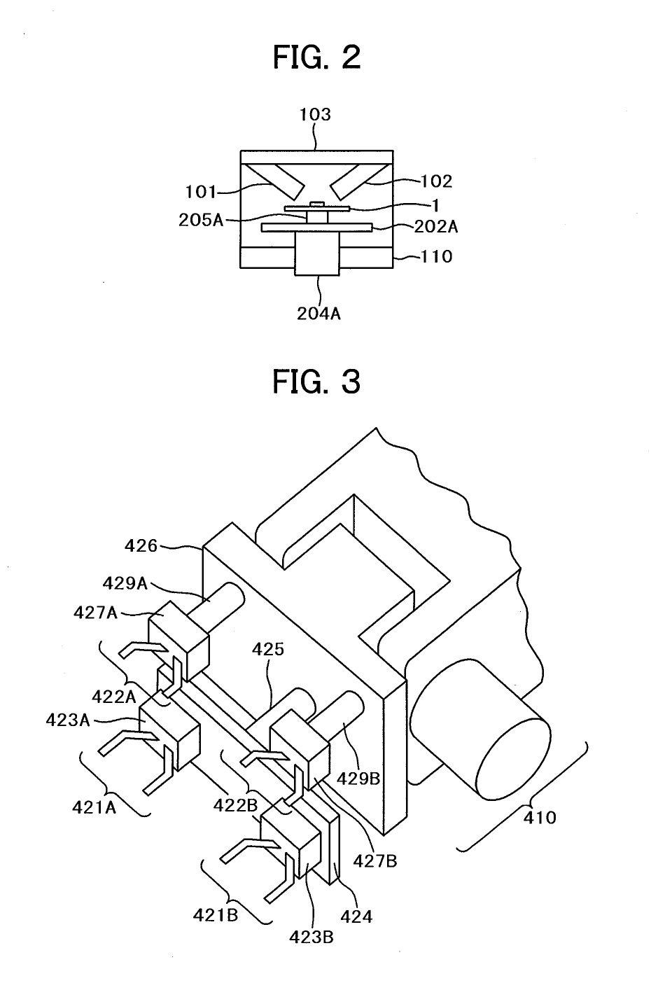

Referring to FIG. 2, the optical inspection units 100A, 100B each include an illumination optical system 101 and a detection optical system 102. The illumination optical system 101 obliquely sends light to the front surface of a magnetic disk 1 as an inspection object. The detection optical system 102 detects the light reflected from the front surface of the magnetic disk irradiated with the light from the illumination optical system. The illumination optical system 101 and the detection optical system 102 are supported by a frame 103. Each of the optical inspection units 100A and 100B can inspect the magnetic disk 1 while continuously moving a table portion 110 in a reciprocating direction. The table portion 110 on which the frame 103 is mounted can be moved at least in the reciprocating direction denoted with arrow in FIG. 1B. Each of the optical inspection units 100A and 100B obtains signals by detecting the light reflected from the magnetic disk 1. Such signals are processed by the signal processing and control unit 600 to detect defects such as flaws, foreign matter, etc.

The signal processing and control unit 600 divides the defects of the inspected magnetic disks 1 into corresponding grades in accordance with the dimension and number (density) of detected flaws, foreign matter and the like and stores the grades of the defects in relation to the corresponding inspected magnetic disks 1.

The table unit 200A is provided with a motor 201A and a table 202A is driven by the motor 201A to rotate. The table unit 200B is provided with a motor 201B and a table 202B is driven by the motor 201B to rotate. Table rotation-drive motors 203A, 204A are secured to the table 202A. A spindle 205A is connected to and driven by the motor 203A to rotate. A spindle 206A is connected to and driven by the motor 204A to rotate. Respective leading end portions of the spindles 205A, 206A are each formed to be fitted into a hole of a central portion of the magnetic disk 1 as an inspection object so as to be able to hold the magnetic disk 1.

Similarly, motors 203B, 204B are secured to the table 202B. A spindle 205B is connected to and driven by the motor 203B to rotate. A spindle 206B is connected to and driven by the motor 204B to rotate.

The table 202A is driven by the motor 201A to turn 180 degrees in a reciprocation manner so that the respective positions of the spindles 205A and 206A are moved between an inspection position 250A where an inspection is performed by the optical inspection unit 100A (the position of the magnetic disk 1 in FIG. 1A) and a disk delivery and reversal position 260A (the position of a magnetic disk 1′ in FIG. 1A).

Similarly, also the table 202B is driven by the motor 201B to turn 180 degrees in a reciprocation manner.

The board handling unit 400 includes an articulated robot 410 and a chuck portion 420 attached to the leading end portion of the articulated robot 410. The chuck portion 420 has two pairs of chucks installed in two stages, i.e., upper chucks and lower chucks for each of the tables 202A, 202B.

FIG. 3 illustrates the configuration of the chuck portion 420. Chucks 421A and 421B are installed in the lower stage so as to correspond to the tables 202A and 202B, respectively. In addition, chucks 422A and 422B are installed in the upper stage so as to correspond to the tables 202A and 202B, respectively.

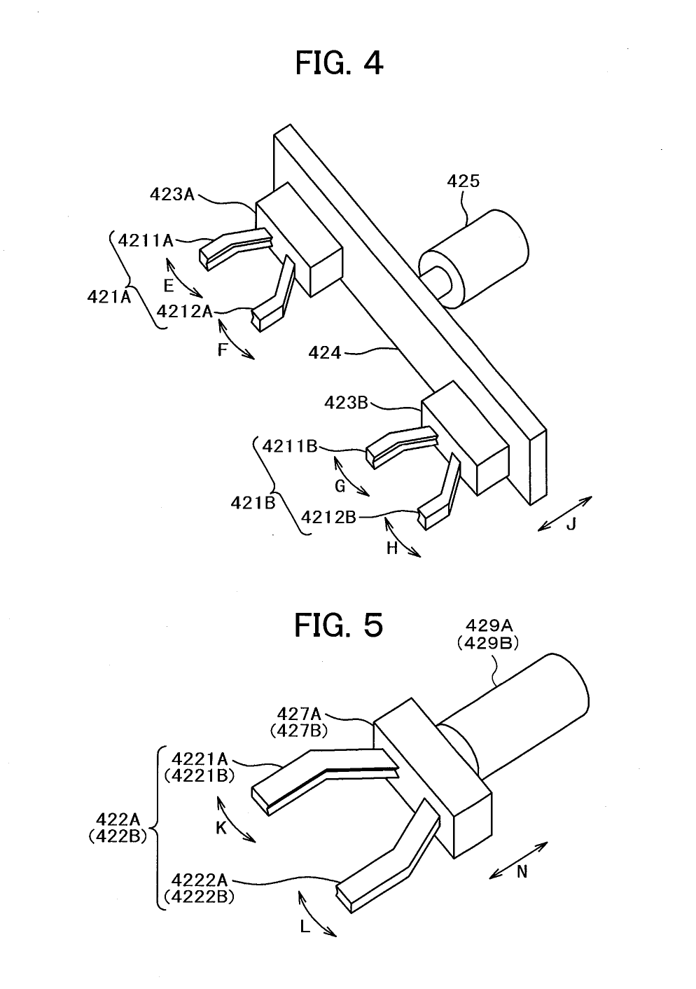

FIG. 4 illustrates the configuration of the chucks 421A, 421B in the lower stage. The chuck 421A has a pair of claws 4211A, 4212A. The claws 4211A, 4212A are driven by a claw drive portion 423A to be operatively opened and closed in the directions of arrows E and F in FIG. 4 to grip and release the magnetic disk 1.

Similarly, also the chuck 421B has a pair of claws 4211B, 4212B. The claws 4211B, 4212B are driven by a claw drive portion 423B to be operatively opened and closed in the directions of arrows G and H in FIG. 4 to grip and release the magnetic disk 1.

The chucks 421A, 421B are secured to a common support plate 424. The support plate 424 is driven in a back and forth direction (the direction of arrow J) by a first arm cylinder 425 secured to a base plate 426.

FIG. 5 illustrates the configuration of the chuck 422A. The chuck 422A includes a pair of claws 4221A, 4222A. The claws 4221A, 4222A are driven by a claw drive portion 427A to be operatively opened and closed in the directions of arrows K, L in FIG. 5 to grip and release the magnetic disk 1. The claw drive portion 427A is driven in a back and forth direction (the direction of arrow N: parallel to the direction of arrow J) by a second arm cylinder 429A secured to the base plate 426.

The configuration of the chuck 422B is the same as that of the chuck 422A described in FIG. 5; therefore, parenthetic reference numerals are each denoted under the reference numeral of a corresponding one of the constituent elements in FIG. 5.

The cassette unit 500 includes a supply cassette 510, an accepted piece cassette 520, a one-side defective piece cassette 530, and a both-sides rejected piece cassette 540. The accepted piece cassette 520 stores magnetic desks inspected and determined to be accepted pieces. The one-side rejected piece cassette 530 stores magnetic desks whose one-sides were determined to be defective. The both-sides rejected piece cassette 540 stores magnetic disks whose both-sides were determined to be defective. These cassettes are each designed to be movable along a corresponding one of rails 550, 560.

With such a configuration, the chuck portion 420 is driven by the articulated robot 410. The chucks 421A, 421B chuck corresponding magnetic disks 1 stored in the supply cassette 510 and mount those respectively to the spindle 205A waiting at the board delivery and reversal position 260A of the optical inspection unit A 100a and the other to the spindle 205B waiting at the board delivery and reversal position 260B of the optical inspection unit B 100b. In this case, the chucks 421A, 421A are concurrently and similarly operated; therefore, drive sources used to move the chucks 421A, 421B in the J-direction in FIG. 4 can share the first arm cylinder 425.

On the other hand, the chucks 422A, 422B chuck the corresponding magnetic disks 1 which are transferred to the corresponding board delivery and reversal positions 260A, 260B after one side of each of the magnetic disks 1 have been inspected by the corresponding optical inspection units 100A, 100B, remove them from spindles 205A, 205B to reverse, and mount them again to the corresponding spindles 205A, 205B.

The chucks 421A, 421B chuck the magnetic disks 1 which have been transferred to the corresponding board delivery and reversal positions 260A, 260B after both sides thereof have been inspected by the corresponding optical inspection units 100A, 100B, and remove them from the corresponding spindles 205A, 205B for store the chucked magnetic disks 1 into any one of the accepted piece cassette 520, the one-side rejected piece cassette 530 and the both-sides rejected piece cassette 540 in accordance with the inspection results. In this case, the magnetic disk held by the chuck 421A and that held by chuck 421B not necessarily have the same inspection results. Therefore, the chucks 421A, 421B differ from each other in movement when the magnetic disks are stored into the cassettes in some cases. Thus, the chucks 422A, 422B are configured to be separately driven by the second arm cylinder 429A and 429B, respectively.

The board reversing unit 300 includes a pair of board chuck portions 310A, 310B, a chuck portion base 320 holding the board chuck portions 310A, 310B, and a vertically movable table portion 330 on which the chuck portion base 320 is mounted.

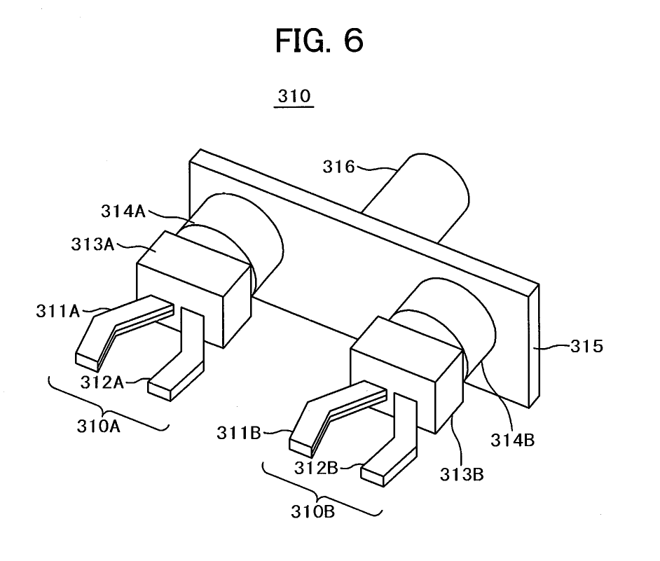

FIG. 6 illustrates the detailed configuration of the board chuck portion 310A. The board chuck portion 310A is configured to include a pair of claws 311A, 312A, a claw drive portion 313A to drive opening and closing the pair of claws 311A, 312A, and a rotation-drive portion 314A rotating the claw drive portion 313A and the pair of claws 311A, 312A by 180 degrees. Also the board chuck portion 310B has the same configuration as the board chuck portion 310A; therefore, its explanation is omitted. The rotation-drive portion 314A for the board chuck portion 310A and the rotation-drive portion 314B for the board chuck portion 310B are secured to a support plate 315. This support plate 315 is driven in the back and forth direction by a fourth arm cylinder 316. The fourth arm cylinder 316 is fixed and held by the chuck portion base 320.

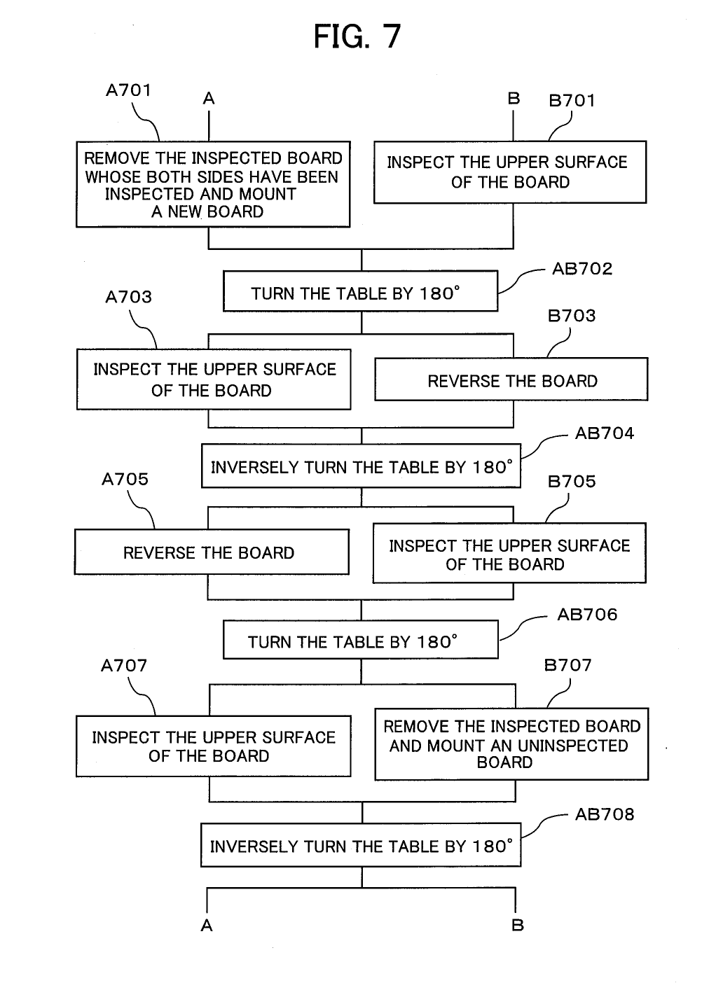

In the configuration described above, a description is given of a series of the operations as below. The magnetic disks 1 are taken out from the cassette unit 500 by the board handling unit 400 and fed to the table units 200A, 200B. The magnetic disks 1 are inspected by the optical inspection units 100A, 100B and are returned to the cassette unit 500. This procedure will be described by referring FIG. 7 to FIG. 10.

A description is first given of a procedure for sequentially inspecting magnetic disks in the apparatus configuration illustrated in FIG. 1A. The processing performed by the combination of the optical inspection unit 100A and the table 202A is the same as that performed by the combination of the optical inspection unit 100B and the table 202B. Therefore, to simplify the explanation, a description is given of the processing performed by the combination of the optical inspection unit 100A and the table 202A. In FIG. 7, symbol “A” denotes processing performed on the board (the magnetic disk) held by the spindle 207A; symbol “B” denotes processing performed on the board (the magnetic disk) held by the spindle 206A.

First, at the board delivery and reversal position 260A, the board (the magnetic disk) whose both sides have been inspected is removed from the spindle 207A and a new board is mounted to the spindle 207A (A701). On the other hand, at the inspection position 250A, one surface (the upper surface) of the board held by the spindle 206A is inspected by use of the optical inspection unit 100A (B701). Next, the table 202A is turned 180 degrees to shift the board newly mounted to the spindle 207A at the board delivery and reversal position 260A to the inspection position 250A. In addition, the board having been inspected at the inspection position 250A and held by the spindle 206A is shifted to the board delivery and reversal position 260A (AB702).

Next, one side of the board held by the spindle 207A is inspected at the inspection position 250A by use of the optical inspection unit 100A (A703). The board held by the spindle 206A is removed from the spindle 206A and reversed at the board delivery and reversal position 260 and is again held by the spindle 206A in the state where the side not subjected to inspection faces upward (B703). Next, the table 202A is inversely turned 180 degrees to shift the spindle 207A holding the board whose one side has been inspected at the inspection position 250A to the board delivery and reversal position 250A. At the same time, the spindle 206A holding the reversed board is shifted to the inspection position 250A (AB704).

Next, the board whose one side has been inspected and is held by the spindle 207A at the board delivery and reversal position 260A is removed from the spindle 207A, reversed and again held by the spindle 207A in the state where the surface which is not subjected to the inspection faces upward (A705). On the other hand, at the inspection position 250A, the other side of the board which has been held by the spindle 207A and whose one side has already been inspected is inspected (B705). Next, the table 202A is turned 180 degrees to shift the spindle 207A holding the reversed board to the inspection position 250A. At the same time, the spindle 206A holding the board both sides of which have been inspected is shifted to the board delivery and reversal position 260A (AB706).

Next, at the inspection position 250A, the board reversed and held by the spindle 207A is inspected by use of the optical inspection unit 100A (A707). On the other hand, at the board delivery and reversal position 260A, the board which is held by the spindle 206A and whose both sides have been inspected is removed from the spindle 206A and a new board is mounted to the spindle 206A (B707). Next, the table 202A is inversely turned 180 degrees to shift the spindle 207A holding the board both sides of which have been inspected at the inspection position 250A to the board delivery and reversal position 260A. In addition, the spindle 206A holding a newly fed board is shifted to the inspection position 250A (AB708). Thereafter, the operations from steps A701 and B701 to step AB708 are repeated.

The board upper-side surface inspection performed in each of steps B701, A703, B705 and A707 is performed as below in the state where the spindle 206A is driven and rotated by the motor 204A at the inspection position 250A. While continuously moving the table portion 110 of the optical inspection unit 100A shown in FIG. 2 to the radial direction of the board 1, illumination light is emitted to the upper-side surface of the board 1 from the illumination optical system 102 attached to the table portion 110. The light reflected from the upper-side surface of the board 1 is detected by the detection optical system 102. The signals detected by the detection optical system 102 are inputted into the signal processing and control unit 600. The signals are compared with the threshold value preset in the signal processing and control unit 600 to detect defects. The positional information on the defects thus detected is obtained by use of the positional information about the table portion 110 and the rotation-positional information about the spindle 206A. Further, information such as the types and dimensions of the defects, defect density and the like is extracted by use of the signals and positional information on the defects thus detected. The defects are determined whether or not to be acceptable and thus the grade (the board is to be accepted or rejected) of the board inspected is determined.

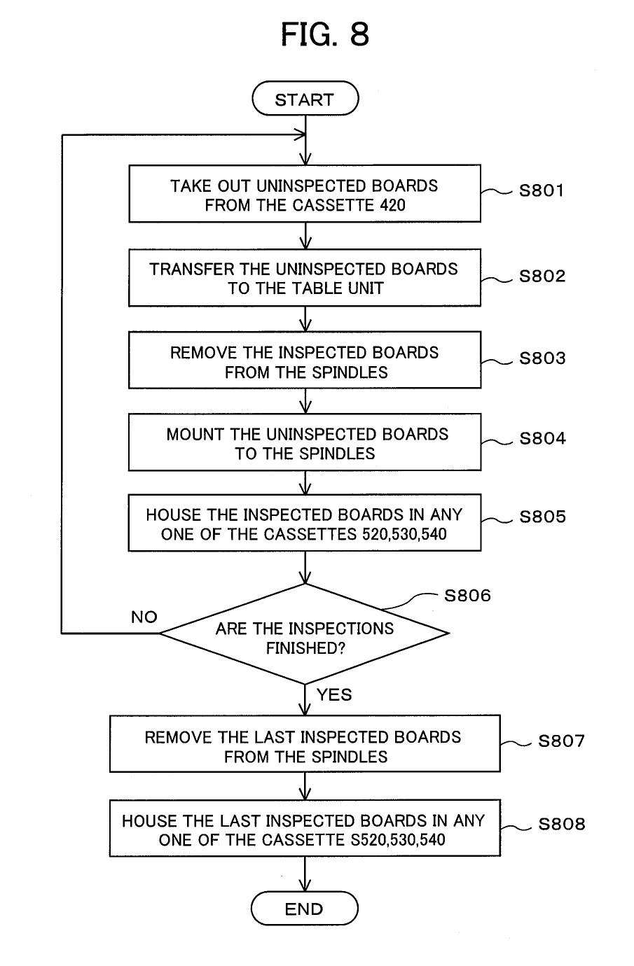

FIG. 8 is a detailed flowchart for the movement of the board handling unit 400 in relation to the steps executed in A701 and B707 in the processing flow described with FIG. 7. In the steps, the board whose both sides have been inspected is removed from the spindle 206A or 207A and a new board is mounted to the spindle 206A or 207A. A description is given of also the movement of delivering the board to the spindles 206B, 207B of the table unit 200B with reference to the flowchart of FIG. 8.

First, the articulated robot 410 is driven to shift the chuck portion 420 to the position of the supply cassette 510. In addition, the chucks 421A, 421B chuck corresponding magnetic disks, which vertically stand in a row in the supply cassette 510, and take them out from the supply cassette 510 (S801). Next, the articulated robot 410 is pivoted and transfers the magnetic disks taken out from the supply cassette 510, to the respective board delivery and reversal positions 260A, 260B of the table units 200A, 200B (S802).

Next, the magnetic disks whose both sides have been inspected are removed from the corresponding spindles 207A, 207B (S803). The new magnetic disks having been transferred from the supply cassette 510 are mounted to the corresponding spindles 207A, 207B (S804). Next, the magnetic disks which have been removed from the corresponding spindles 207a, 207B after both sides thereof have been inspected are stored into any one of the accepted piece cassette 520, the one-side rejected cassette 530 and the both-sides rejected cassette 540 in response to the inspection results (S805).

Next, it is checked whether or not all the boards are carried in to the inspection apparatus. When the board or boards to be inspected are left, process is returned to step S801 to continue the processing. On the other hand, when all the boards are carried in to the inspection apparatus, at the point of time when the inspection of the last carried-in board is completed, this board is removed from the spindle 207A or 207B. The removed board is stored in any one of the accepted piece cassette 520, the one-side rejected cassette 530 and the both-sides rejected cassette 540 in accordance with the inspection results (S705). Thus, the inspection is completed.

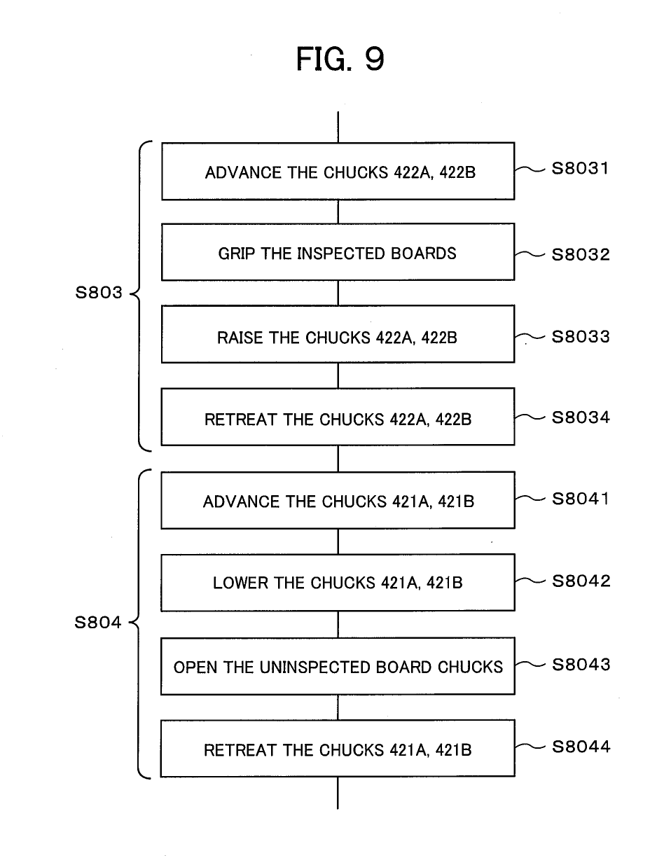

In the step S803, the magnetic disks whose both sides have been inspected are removed from the corresponding spindles 207A, 207B. In step S804, the new magnetic disks transferred from the supply cassette 510 are mounted to the corresponding spindles 207A, 207B. FIG. 9 illustrates a detailed flow of the movement of the chuck portion 420 in steps of S803 and S804 described in FIG. 8.

In step S803, first, the general control unit 600 controls the articulated robot 410 as follows. The chucks 422A and 422B of the chuck portion 420 are operated to face the board delivery and reversal positions 260A and 260B of the tables 202A and 202B, respectively. In this state, the second arm cylinder 429A and the third arm cylinder 429B are operated to advance the chucks 422A and 422B, respectively (S8031). The claw drive portions 427A and 427B are operated to close the claws 4221A, 4222A and the claws 4221B, 4222B, respectively to hold the corresponding magnetic disks which are held by the corresponding spindles 207A, 207B at the corresponding board delivery and reversal positions 260A, 260B after both sides thereof have been inspected (S8032).

Next, the articulated robot 410 is controlled as follows with the boards held thereby. The chucks 422A, 422B are raised (S8033) (raised until the positions of the new boards held by the chucks 421A, 421B are higher than the spindles 207A, 207B), and the boards are removed from the corresponding spindles 207A, 207B. Next, the second arm cylinder 429A and the third arm cylinder 429B are operated to retreat the chucks 422A and 422B, respectively (S8034).

Next, in step S804, the first arm cylinder 425 is operated to advance the new boards held by the chucks 421A, 421B to a position right above the spindles 207A, 207B (S8041). After that, the articulated robot 410 is controlled as follows. The chucks 421A, 421B are lowered (S8042) to transfer the new boards held thereby to the corresponding spindles 207A, 207B. In addition, the claw drive portions 427A and 427B are operated to open the claws 4221A, 4222A and the claws 4221B, 4222B, respectively, thus, opening the chucks (S8043). Next, the first arm cylinder 425 is operated to retreat chucks 421A, 421B (S8044). Thus, the loading of the new boards to the spindles 207A, 207B is completed.

According to the present embodiment, the chuck portion attached to the single articulated robot 410 can concurrently supply the boards to the two corresponding spindles. Therefore, more boards can be processed with a relatively small footprint. Since more boards can be processed by the single articulated robot, they can be processed by less movable mechanisms compared with the case where dedicated board handling means are provided for the corresponding inspection units. Thus, the occurrence of foreign matter contaminating the board can be reduced.

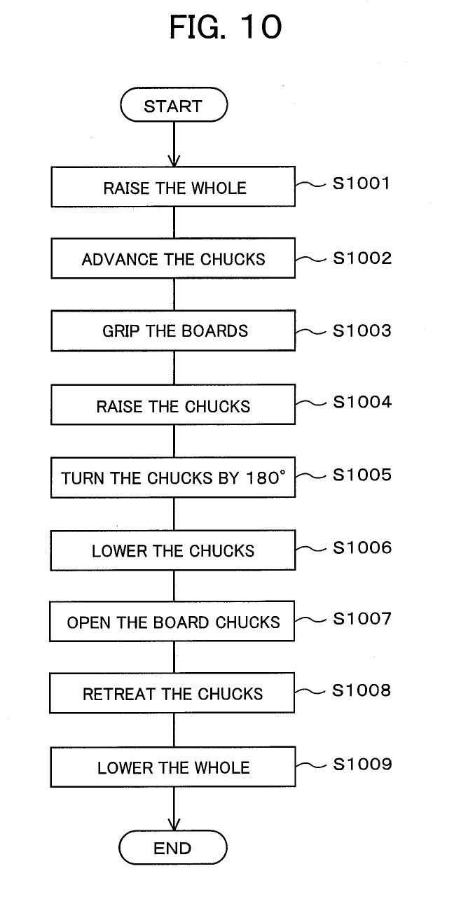

The board reversal processing performed in steps B703 and A705 in FIG. 7 is described below by referring FIG. 10.

In the initial state, the board reversing unit 300 stands by at the position that is the lowermost position (the lowering end) of the board chuck portion 310 in order to avoid the interference with the board handling unit 400. In this state, in the steps B703 and A705, the table portion 330 is first operated to raise the pair of claws 311A, 312A of the board chuck portion 310A and the pair of claws 311B, 312B of the board chuck portion 310B to a position facing to the magnetic disks which are held by the corresponding spindles 207A, 207B at the corresponding board delivery and reversal positions 260A, 260B and whose upper surfaces have been inspected (S1001).

The fourth arm cylinder 316 is then operated to advance the pair of board chuck portions 310A, 310B (S1002). The claw drive portions 313A and 313B are operated to close the claws 311A, 312A and the claws 311B, 312B, respectively, to grip the corresponding disks which are held by the corresponding spindles 207A, 207B (or the spindles 206A, 206B) at the board delivery and reversal positions 260A, 260B after upper surfaces thereof have been inspected (S1003). In the state where the boards are gripped, the table portion 330 is then operated to raise the chucks 310A, 310B (S1004) and the turn-drive portions 314A, 314B are driven to turn the corresponding chucks 310A, 310B by 180 degrees to reverse the boards gripped by the corresponding chucks 310A, 310B to face the uninspected surfaces upside (S1005).

Then, the table portion 330 is operated to lower the chucks 310A, 310B (S1006) and the boards gripped by the corresponding chucks are mounted to the spindles 207A, 207B (or the spindles 206A, 206B). After that, the claw drive portions 313A, 313B are operated to open the claws 311A, 312A and the claws 311B, 312B, respectively, to release the corresponding boards (S1007). The fourth arm cylinder 316 is operated to retreat the pair of board chuck portions 310A, 310B (S1008). After the fourth arm cylinder 316 is finished to operate, the table portion 330 is operated to lower the chucks 310A, 310B to respective retreat positions (S1009). Thus, a series of operations are completed.

As described above, the present embodiment employs the mechanism using the articulated robot as the board handling unit 400 and the chuck portions are configured to deal with the two sets of inspection units concurrently. Although the number of the inspection units is increased, the handling unit can be shared to suppress an increase in the installation floor area (footprint) for the entire apparatus.

The handling unit is shared by the plurality of inspection units to thereby suppress an increase in the number of mechanisms. Therefore, in the state where high throughput is maintained, an increase in the number of dust production sources can be suppressed to reduce the causes of occurrence of foreign matter and defects.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the remaining and range of equivalency of the claims are therefore intended to be embraced therein.

What is claimed is:

1. A magnetic disk inspection apparatus comprising:
an optical inspection unit for optically inspecting a defect on a board;
a table unit including a plurality of board rotation-drive portions on which the boards are put and rotated, the table unit turning for transferring the boards put on the corresponding board rotation-drive portions between a position where the board put on the board rotation-drive portion is inspected by the optical inspection unit and a position where the board is taken out and supplied;
a cassette portion housing a cassette for storing an uninspected board and a cassette for storing an inspected board; and
a board handling unit configured to:
take out the uninspected board from the uninspected-board storing cassette provided in the cassette portion and supply the uninspected board to the board rotation-drive portion of the table unit, and
take out the board having both surfaces subjected to inspection by the optical inspection unit from the board rotation-drive portion and store the board into the inspected-board storing cassette provided in the cassette portion;
wherein the optical inspection unit and the table unit are each provided a plurality of numbers, and the board handling unit concurrently takes out a plurality of boards inspected by the plurality of inspection units from the plurality of table units and concurrently supplies a plurality of uninspected boards to the plurality of table units.

2. The magnetic disk inspection apparatus according to claim 1,
wherein the board handling unit includes a articulated robot and a chuck portion mounted to a leading end portion of the articulated robot, and the chuck portion includes a plurality of sets of chucks adapted to supply the boards to the table unit and chucks adapted to take out the inspected boards from the table unit.

3. The magnetic disk inspection apparatus according to claim 2,
wherein chucks of each set, among the plurality of sets of chucks, used to supply the boards to the table unit share a drive source adapted to move forward and rearward the boards with respect to the table unit.

4. The magnetic disk inspection apparatus according to claim 2,
wherein chucks of each set, among the plurality of sets of chucks, used to take out the inspected boards from the table unit have respective individual drive sources adapted to move forward and rearward the boards with respect to the table unit.

5. The magnetic disk inspection apparatus according to claim 1, further comprising:
a board reversal unit reversing a board which is put on the board rotation-drive portion after one surface thereof has been inspected by the optical inspection unit.

6. The magnetic disk inspection apparatus according to claim 2, further comprising:
a board reversal unit reversing a board which is put on the board rotation-drive portion after one surface thereof has been inspected by the optical inspection unit.

7. The magnetic disk inspection apparatus according to claim 3, further comprising:
a board reversal unit reversing a board which is put on the board rotation-drive portion after one surface thereof has been inspected by the optical inspection unit.

8. The magnetic disk inspection apparatus according to claim 4, further comprising:
a board reversal unit reversing a board which is put on the board rotation-drive portion after one surface thereof has been inspected by the optical inspection unit.

9. A magnetic disk inspection method comprising the steps of:
taking out a plurality of uninspected boards stored in a cassette, from the cassette;
putting the plurality of boards taken out from the cassette on a plurality of corresponding rotation-drive portions at a plurality of corresponding board taking-out and supply positions in a magnetic disk inspection apparatus;
transferring the boards put on the plurality of corresponding rotation-drive portions to a plurality of corresponding inspecting positions;
optically inspecting, through light irradiation, the plurality of boards transferred to the plurality of corresponding inspecting positions while allowing the rotation-drive portions to rotate the plurality of corresponding boards;
transferring the plurality of optically inspected boards to the plurality of corresponding board taking-out and supply positions in a state where the plurality of optically inspected boards are put on the plurality of corresponding rotation-drive portions;
taking out the plurality of optically inspected boards transferred to the plurality of corresponding board taking-out and supply positions; and
sorting the plurality of taken-out boards in accordance with results of the optical inspection and storing the sorted boards into corresponding cassettes into which inspected boards are stored.

10. The magnetic disk inspection method according to claim 9,
wherein a chuck portion including a plurality of sets of chucks adapted to put boards on the plurality of rotation-drive portions and chucks adapted to take out the optically inspected board to mount the board to a leading end portion of a articulated robot performs: taking out the plurality of uninspected boards from the cassette to put the plurality of uninspected boards on the plurality of corresponding rotation-drive portion; and taking out the plurality of optically inspected boards, sorting the plurality of optically inspected boards in accordance with the optically inspection results and storing the plurality of optically inspected boards in corresponding cassette used to store the inspected boards therein.

11. The magnetic disk inspection method according to claim 10,
wherein among the plurality of sets of chucks in the chuck portion, chucks used to put the boards on the plurality of corresponding rotation-drive portions are driven by a common drive source to move forward and rearward with respect to the plurality of corresponding rotation-drive portions.

12. The magnetic disk inspection method according to claim 10,
wherein among the plurality of sets of chucks in the chuck portion, chucks used to take out the optically inspected boards are driven by respective individual drive sources to move forward and rearward with respect to the plurality of corresponding rotation-drive portions.

13. The magnetic disk inspection method according to claim 11,
wherein among the plurality of sets of chucks in the chuck portion, chucks used to take out the optically inspected boards are driven by respective individual drive sources to move forward and rearward with respect to the plurality of corresponding rotation-drive portions.

14. The magnetic disk inspection method according to claim 9,
wherein the plurality of boards are, the boards having been optically inspected through light irradiation while being rotated by the plurality of corresponding rotation-drive portions, transferred to a plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.

15. The magnetic disk inspection method according to claim 10,
wherein the plurality of boards are, the boards having been optically inspected through light irradiation while being rotated by the plurality of corresponding rotation-drive portions, transferred to the plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.

16. The magnetic disk inspection method according to claim 11,
wherein the plurality of boards are, the boards having been optically inspected through light irradiation while being rotated by the plurality of corresponding rotation-drive portions, transferred to the plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.

17. The magnetic disk inspection method according to claim 12,
wherein the plurality of boards are, the boards having been optically inspected through light irradiation while being rotated by the plurality of corresponding rotation-drive portions, transferred to the plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.

18. The magnetic disk inspection method according to claim 13,
wherein the plurality of boards are, the boards having been optically inspected through light irradiation while being rotated by the plurality of corresponding rotation-drive portions, transferred to the plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.

19. The magnetic disk inspection method according to claim 14,
wherein the plurality of boards are, the boards having been optically inspected through light irradiation while being rotated by the plurality of rotation-drive portions, transferred to the plurality of corresponding board taking-out and supply positions, concurrently reversed at the plurality of corresponding board taking-out and supply positions, and transferred with the boards keeping the reversed state thereof to the corresponding inspecting positions to be inspected, thus completing the optical inspection of the plurality of boards.
